(19) United States
(12) Patent Application Publication
(10) Pub. No.: US 2011/0211133 A1
(43) Pub. Date: Sep. 1, 2011

(54) OPTICAL SHEET LAMINATE, BACKLIGHT DEVICE, DISPLAY DEVICE, AND TELEVISION RECEIVER

(75) Inventor: Kentaro Kamada, Osaka-shi (JP)

(73) Assignee: SHARP KABUSHIKI KAISHA, Osaka-shi, Osaka (JP)

(21) Appl. No.: 13/123,278

(22) PCT Filed: Oct. 13, 2009
(86) PCT No.: PCT/JP2009/067699

§ 371 Date: Apr. 8, 2011

(30) Foreign Application Priority Data
Nov. 10, 2008 (JP) 2008-287924

(51) Int. Cl. H04N 5/66; G02B 5/02; G02F 1/13357

(52) U.S. Cl. 348/739; 359/599; 362/97.2; 349/64; 348/E05.133

(57) ABSTRACT

An optical sheet laminate 40 arranged between a light source 24 and a display panel 11 for displaying an image by using light emitted from the light source, the optical sheet laminate 40 being constituted by laminating a diffuser plate 41 for diffusing light emitted from the light source 24 and an optical sheet 43 for transmitting light emitted from the diffuser plate 41, wherein the optical sheet 43 and the diffuser plate 41 are adhered by an adhesive layer 44 attached partially within an area provided so as to oppose to a display area of the display panel 11.

### TECHNICAL FIELD

The present invention relates to an optical sheet laminate, a backlight device, a display device, and a television receiver which are arranged between a light source and a display panel.

### BACKGROUND ART

Conventionally, a display device described in patent literature 1 has been known as the one having a display panel and a backlight device for displaying an image on the display panel. The backlight device is arranged in the back side of the display panel and has a light source and an optical sheet laminate. The optical sheet laminate is arranged between the light source and the display panel and constituted by laminating a diffuser plate for diffusing light emitted from the light source and an optical sheet for transmitting light emitted from the diffuser plate. The optical sheet is arranged in the front side of the diffuser plate.

A space is provided between the display panel and the optical sheet, preventing damages caused by grazing therebetween.

Additionally, an air layer is provided between the optical sheet and the diffuser plate, so as to cope with the case where a total reflection occurs when light is about to fall on from a medium having a higher refractive index to a medium having a lower refractive index. In other words, an air layer having a lower refractive index than the optical sheet is provided as a space between the optical sheet and the diffuser plate, so that reduction of luminance caused by a total reflection occurred when light falls on from the diffuser plate to the optical sheet is prevented.
[Patent literature 1]: Japanese Unexamined Patent Publication No. 2008-204818

### PROBLEM TO BE SOLVED BY THE INVENTION

The circumferential edges of the display panel and the optical sheet laminate are held by a plurality of frame-shaped holding members. In thermal expansion, the optical sheet cannot therefore expand in the surface direction, and may cause, for example, a deflection of the central part of the optical sheet, being separated from the diffuser plate and swelled. Recently, the display devices are becoming larger, and thus, the deflection amount (amount of being separated from the diffuser plate and swelling) of the optical sheet may increase. In response, it is concerned that the deflected part of the optical sheet approaches or comes in contact with the display panel, causing a wrinkle in the optical sheet and deteriorating the display quality.

### DISCLOSURE OF THE INVENTION

The present invention has been completed based on the above circumstances, and its purpose is to provide an optical sheet laminate, a backlight device, a display device, and a television receiver which are capable of preventing deterioration of display quality.

### MEANS FOR SOLVING THE PROBLEM

An optical sheet laminate of the present invention arranged between a light source and a display panel for displaying images using light emitted from the light source includes a diffuser plate and an optical sheet. The diffuser plate is configured to diffuse light emitted from the light source. The light from the diffuser plate passes through the optical sheet. The optical sheet is bonded to the diffuser plate with an adhesive applied to a part of an area thereof opposite a display area of the display panel.

With such a configuration, the optical sheet is partially constrained by the diffuser plate, thereby reducing the deflection amount of the optical sheet as compared with the case where the entire optical sheet is deflected. Wrinkles therefore become inconspicuous, and deterioration of display quality can be prevented. And also, when the refractive index of the adhesive is assumed to be greater than that of the optical sheet, it is concerned that light emitted from the diffuser plate is totally reflected when falling from the adhesive onto the optical sheet, lowering the luminance. However, the adhesive is applied only to a part of the optical sheet, and the luminance is less likely to be lowered.

### BRIEF DESCRIPTION OF THE DRAWINGS

FIG. 1 is an exploded perspective view schematically showing a television receiver according to the present embodiment;

FIG. 2 is an exploded perspective view schematically showing a liquid crystal display device;

FIG. 3 is a cross sectional view showing a cross-sectional structure of the liquid crystal display device taken in the short-width direction;

FIG. 4 is a cross sectional view showing a cross-sectional structure of the liquid crystal display device taken in the longitudinal direction;

FIG. 5 is a schematic diagram showing a cross-sectional structure of an optical sheet laminate adhered by multiple adhesive layers;

FIG. 6 is a schematic diagram showing a plane arrangement of the multiple adhesive layers;

FIG. 7 is a schematic diagram showing a plane arrangement of the adhesive layers in the optical sheet laminate according to other embodiment (5);

FIG. 8 is a schematic diagram showing a cross-sectional structure of the optical sheet laminate according to Other embodiment (6).

### BEST MODE FOR CARRYING OUT THE INVENTION

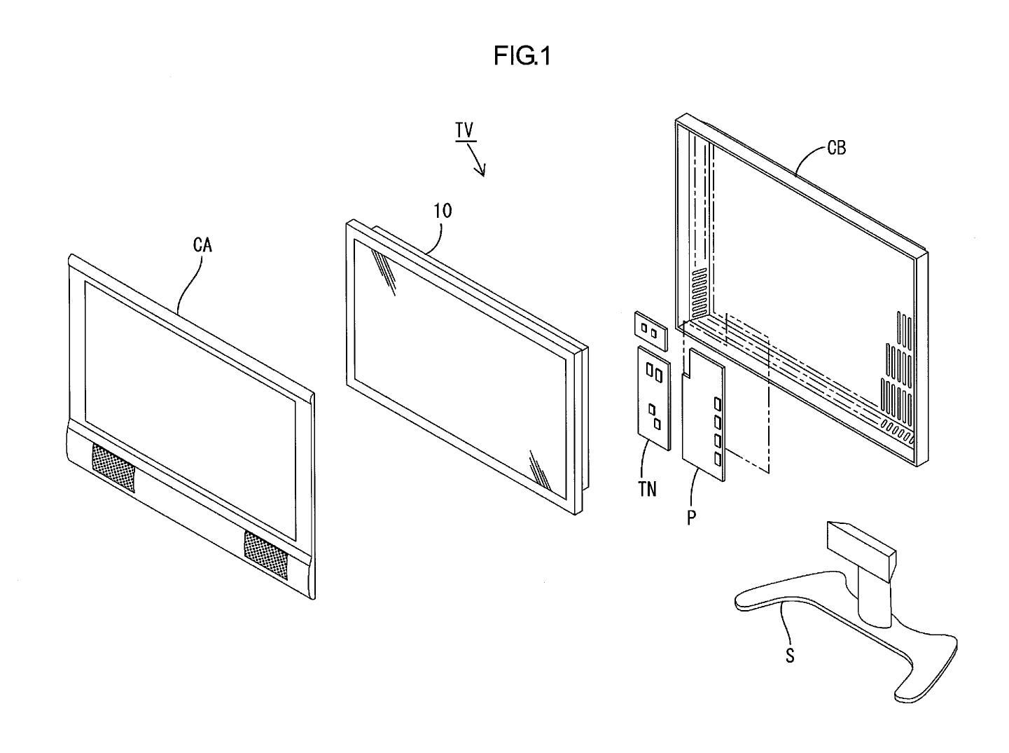

In what follows, Embodiment 1 of the present invention is explained in reference to FIGS. 1 to 6. In the present embodiment, a television receiver TV comprising a liquid crystal display device (display device) is described as an example. The television receiver TV is constituted by comprising, as shown in FIG. 1, the liquid crystal display device 10, cabinets CA and CB for housing the liquid crystal display device 10 in a manner so as to hold the device from the front and the rear sides, a power source P, a tuner TN for receiving a television broadcast and the like, and a stand S. The liquid crystal display device 10 is housed within the cabinets CA and CB in a stand posture, with the display face faced in a nearly perpendicular direction. FIG. 1 is shown, in which the lower left side (the front side of the television receiver TC, display side) is the front side, while the upper right side is the rear side.

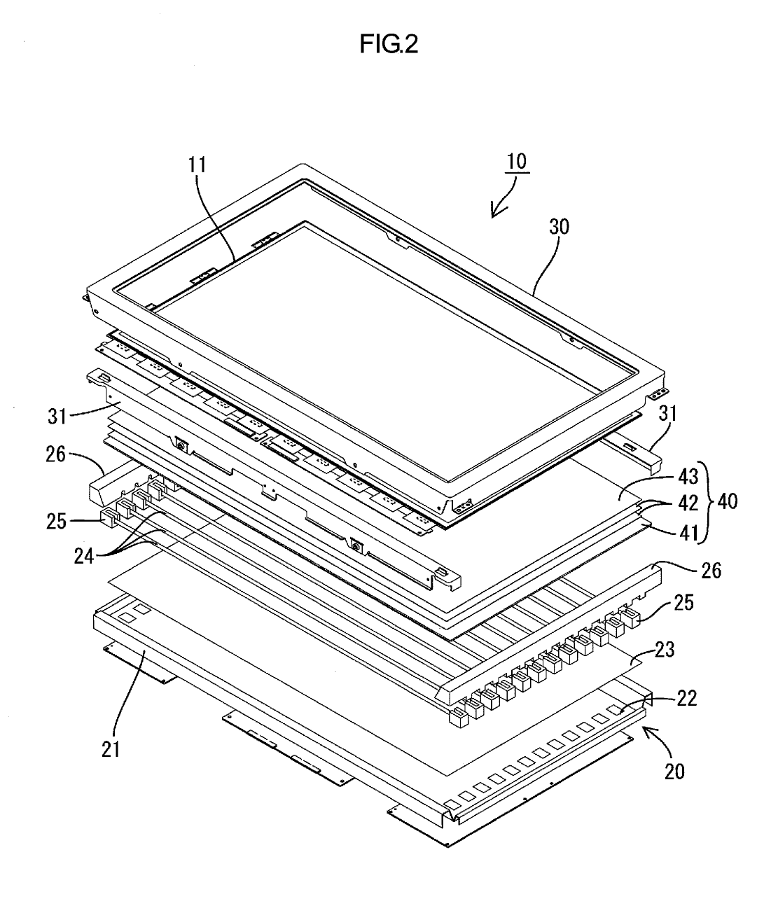

The liquid crystal display device 10 has a laterally long rectangular shape on the whole, and is constituted by, as shown in FIG. 2, having a liquid crystal panel 11 (corresponding to a display panel in the present invention) for displaying images and a backlight device 20 as an external light source for illuminating light toward the liquid crystal panel 11, both held integrally by a holding member such as a bezel 30.

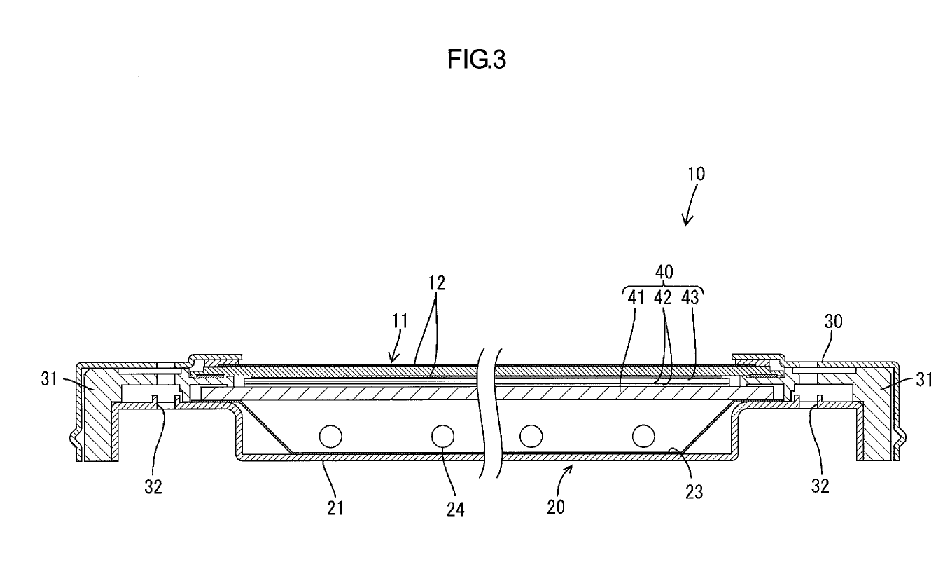

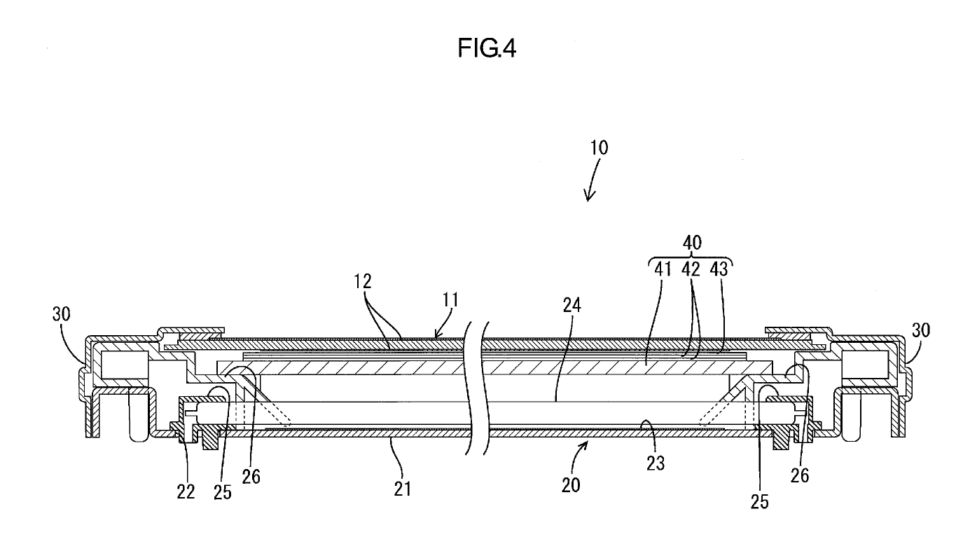

The liquid crystal panel 11 has a pair of transparent (having translucency) glass boards in a laterally long rectangular shape and a liquid crystal layer (not shown) between both boards whose optical property changes in accordance with voltage application. In addition, polarizing plates 12 are attached to the front and rear faces of the liquid crystal panel 11 (see FIGS. 3 and 4).

The frame-shaped bezel 30 is provided in the front side of the liquid crystal panel 11. The liquid crystal panel 11 is supported, with its circumferential edge held between the bezel 30 and a frame 31, or between the bezel 30 and a holder 26 (see FIGS. 3 and 4). A fixing hole 32 capable of fixing a screw and the like not shown for integrally holding the circumferential edge of the bezel 30, the frame 31, and the circumferential edge of a chassis 21 is provided in multiple positions by penetrating in the front and rear direction (see FIG. 3).

The backlight device 20 is so-called a direct type backlight device and arranged right under the rear surface of the liquid crystal panel 11. The backlight device 20 comprises the chassis 21 in a shallow dish shape concaved in the rear surface side. The chassis 21 is made of metal and has a laterally long rectangular shape as a whole. Attaching holes 22 for attaching a connector 25 are provided in multiple positions in both end edges in the longitudinal direction of the bottom plate of the chassis 21 (see FIGS. 2 and 4).

A reflective sheet 23 is arranged in the bottom surface of the chassis 21. The reflective sheet 23 is made of a synthetic resin and has a white surface which is superior in the light reflectivity. The reflective sheet 23 covers the nearly entire surface of the bottom plate of the chassis 21. Both end edges in the short-width direction of the reflective sheet 23 (the upper edge and the lower edge) are held between the circumferential edge of the chassis 21 and the circumferential edge of the later-described diffuser plate 41 (see FIG. 3). The reflective sheet 23 reflects the light emitted from the later-described light source (in the present embodiment, a cold cathode fluorescent lamp 24) to the front side (to the liquid crystal panel 11).

The cold cathode fluorescent lamp 24 is provided inside the chassis 21. A plurality of cold cathode fluorescent lamps 24 are aligned, with their axial directions coincided with the longitudinal direction of the chassis 21 (see FIG. 2). Each cold cathode fluorescent lamp 24 is supported on its central part in the axial direction by a lamp clip not shown provided on the surface of the reflective sheet 23. Additionally, both ends of the cold cathode fluorescent lamp 24 are connected to the connectors 25 respectively, and all the ends of the cold cathode fluorescent lamps 24 and the connectors 25 are covered collectively by the holder 26 (see FIG. 4).

The optical sheet laminate 40 is provide on the surface of the chassis 21. The optical sheet laminate 40 is constituted by laminating the diffuser plate 41, two diffuser sheets 42 arranged in the front side of the diffuser plate 41, and a reflection-type polarizing plate 43 (corresponding to an optical sheet in the present invention) arranged in the front side of the two diffuser sheets 42. The optical sheet laminate 40 converts the light emitted from the cold cathode fluorescent lamp 24 into planar light.

The diffuser plate 41 is in a nearly rectangular shape, covering the opening of the chassis 21. The diffuser plate 41 is constituted by arranging and dispersing light scattering particles on a plate member made of synthetic resin and diffuses linear light emitted from the cold cathode fluorescent lamp 24 as a linear light source. The thickness of the diffuser plate 41 is around between 1.5 and 4.0 mm.

Both end edges in the short-width direction of the diffuser plate 41 are fixed and held by the upper edge and the lower edge in the circumferential edge of the chassis 21 (the upper edge and the lower edge of the reflective sheet 23) and the frames 31 (see FIG. 3). Both end edges in the longitudinal direction of the diffuser plate 41 are mounted in the holder 26, without being directly constrained (see FIG. 4). Additionally, a pair of frames 31 is provided along both end edges in the short-width direction of the diffuser plate 41.

The two diffuser sheets 42 and the reflection-type polarizing plate 43 have a nearly rectangular shape that is smaller than the diffuser plate 41, and their both end edges in the longitudinal direction are constrained by being held between both end edges in the diffuser plate 41 mounted in the holder 26 and both end edges of the liquid crystal panel 11 held between the holder 26 and the bezel 30 (see FIG. 4). In addition, both end edges in the short-width direction of the two diffuser sheets 42 and the reflection-type polarizing plate 43 are supported without being constrained, with the frame 31 interposed between the diffuser plate 41 and the liquid crystal panel 11 (see FIG. 3). The planar shapes of the diffuser sheet 42 and the reflection-type polarizing plate 43 are nearly the same, and so as their sizes.

The diffuser sheet 42 is a semi-transparent sheet for dispersing and diffusing light and has main functions for making the entire surface have a nearly even luminance and focusing light for a certain level. The thickness of each diffuser sheet 42 is around 210 to 270 μm.

The reflection-type polarizing plate 43 transmits only a prescribed polarization component and reflects other polarization components. The thickness of the reflection-type polarizing plate 43 is around 550 μm. For example, DBEF of Sumitomo 3M Ltd. and the like may be used as the reflection-type polarizing plate 43. A space around 5 mm is provided between the reflection-type polarizing plate 43 and the liquid crystal panel 11.

In addition, the configuration of the optical sheet laminate 40 is not limited to the above and may be the combination of various sheets as necessary.

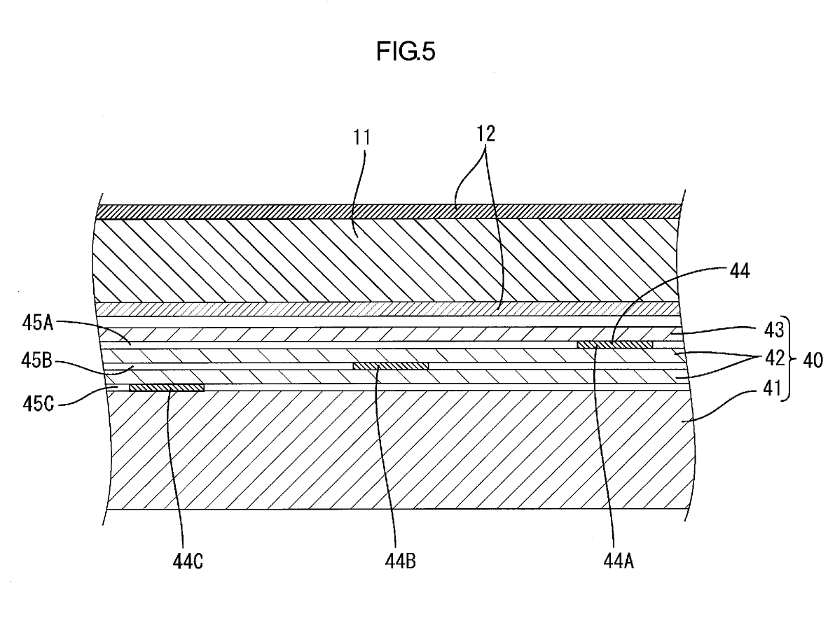

The reflection-type polarizing plate 43 is adhered to the diffuser plate 41 by the adhesive layer 44. Specifically, the reflection-type polarizing plate 43 is adhered by the adhesive layer 44 to the diffuser sheet 42 arranged right behind, and the diffuser sheet 42 is adhered to the other diffuser sheet 42 by the adhesive layer 44, and then this diffuser sheet 42 is adhered to the diffuser plate 41 by the adhesive layer 44. This consequently adheres the reflection-type polarizing plate 43 to the diffuser plate 41 (see FIG. 5). A first space 45A is provided between the reflection-type polarizing plate 43 and the diffuser sheet 42, while a second space 45B is between the two diffuser sheets 42, and a third space 45C is between the diffuser sheet 42 and the diffuser plate 41. In addition, a first adhesive layer 44A is the adhesive layer 44 adhering the optical sheet and the diffuser sheet 42 (the adhesive layer 44 arranged in the first space 45A), a second adhesive layer 44B is the adhesive layer 44 adhering the two diffuser sheets 42 (the adhesive layer 44 arranged in the second space 45B), and a third adhesive layer 44C is the adhesive layer 44 adhering the diffuser sheet 42 and the diffuser plate 41 (the adhesive layer 44 arranged in the third space 45C).

Each adhesive layer 44 is attached within an area in the reflection-type polarizing plate 43, the diffuser sheet 42, and the diffuser plate 41, the area arranged so as to oppose to a display area of the liquid crystal panel 11. The adhesive layer 44 is attached in a streak shape (a thin and long band shape) extending straight (linearly), and its width is around 5 to 10 mm. The thickness of the adhesive layer 44 is as thin as possible, and specifically, around several μm to several tens of μm. This makes each of the first space 45A, the second space 45B, and the third space 45C a very narrow space, comparing to the space between the liquid crystal panel 11 and the reflection-type polarizing plate 43. The adhesive layer 44 may be a well-known adhesive member, such as, for example, a double sided tape.

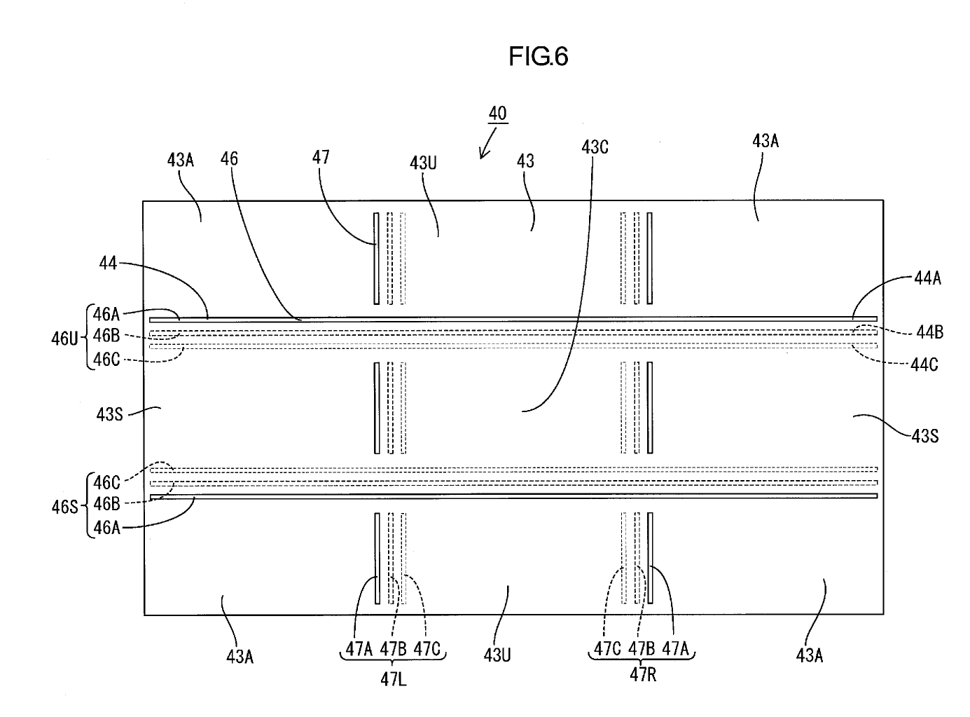

The optical sheet laminate 40 has the longitudinal adhesive member 46 constituted by attaching the adhesive layer 44 in a thin and long band shape extending in a direction along the longitudinal (horizontal) side edge of the reflection-type polarizing plate 43 and the short-width direction adhesive member 47 constituted by attaching the adhesive layer 44 in a thin and long band shape extending in a direction along the short-width (vertical) side edge of the reflection-type polarizing plate 43 (see FIG. 6).

The longitudinal adhesive member 46 has a first longitudinal adhesive member 46A constituted by extending the first adhesive layer 44A in the horizontal direction, a second longitudinal adhesive member 46B constituted by extending the second adhesive layer 44B in the horizontal direction, and a third longitudinal adhesive member 46C constituted by extending the third adhesive layer 44C in the horizontal direction.

A pair of each of the first longitudinal adhesive members 46A, the second longitudinal adhesive members 46B, and the third longitudinal adhesive members 46C are provided, and the total number of the longitudinal adhesive members 46 is six. The longitudinal adhesive member 46 extends continuously in the longitudinal direction of the reflection-type polarizing plate 43 and has a length across nearly the entire length in the longitudinal direction of the reflection-type polarizing plate 43 excepting both end edges. All the longitudinal adhesive members 46 are arranged in positions deviated in the vertical direction (in the short-width direction of the reflection-type polarizing plate 43), being nearly in parallel with each other. In particular, a pair of the second longitudinal adhesive members 46B is arranged inside a pair of the first longitudinal adhesive members 46A, while a pair of the third longitudinal adhesive members 46C is arranged inside the pair of the second longitudinal adhesive members 46B. The first longitudinal adhesive members 46A, the second longitudinal adhesive members 46B, and the third longitudinal adhesive members 46C are deviated from each other in the surface direction (the vertical direction) of the reflection-type polarizing plate 43.

The first longitudinal adhesive member 46A, the second longitudinal adhesive member 46B, and the third longitudinal adhesive member 46C in the upper side of the reflection-type polarizing plate 43 are arranged close to each other, forming an upper longitudinal adhesive member group 46U. The first longitudinal adhesive member 46A, the second longitudinal adhesive member 46B, and the third longitudinal adhesive member 46C in the lower side of the reflection-type polarizing plate 43 are arranged close to each other, forming a lower longitudinal adhesive member group 46S. The upper longitudinal adhesive member group 46U and the lower longitudinal adhesive member group 46S are arranged in positions that divide the optical sheet laminate 40 nearly equally into three in the short-width direction. The spaces between the longitudinal adhesive members 46 constituting each of the longitudinal adhesive member groups 46U and 46S are nearly the same. All the longitudinal adhesive members 46 are arranged in line-symmetric positions across a center line in the short-width direction (vertical direction) of the optical sheet laminate 40.

The short-width direction adhesive member 47 extends continuously in the short-width direction of the reflection-type polarizing plate 43 and has a first short-width direction adhesive member 47A constituted by extending the first adhesive layer 44A in the vertical direction, a second short-width direction adhesive member 47B constituted by extending the second adhesive layer 44B in the vertical direction, and a third short-width direction adhesive member 47C constituted by extending the third adhesive layer 44C in the vertical direction.

Six of each of the first short-width direction adhesive members 47A, the second short-width direction adhesive members 47B, and the third short-width direction adhesive members 47C are provided, and totally, eighteen short-width direction adhesive members 47 are provided. The first short-width direction adhesive members 47A, the second short-width direction adhesive members 47B, and the third short-width direction adhesive members 47C are arranged in three stages in the vertical direction. In particular, two of each of the first short-width direction adhesive members 47A, the second short-width direction adhesive members 47B, and the third short-width direction adhesive members 47C are arranged between the upper longitudinal adhesive member group 46U and the upper edge of the reflection-type polarizing plate 43 (upper stage), between the longitudinal adhesive member groups 46U and 46S (middle stage), and between the lower longitudinal adhesive member group 46S and the lower edge of the reflection-type polarizing plate 43 (lower stage), respectively.

All the short-width direction adhesive members 47 are arranged in positions deviated in the right and left direction (the longitudinal direction of the reflection-type polarizing plate 43), being nearly in parallel with each other. In particular, a pair of the second short-width direction adhesive members 47B is arranged inside a pair of the first short-width direction adhesive members 47A, while a pair of the third short-width direction adhesive members 47C is arranged inside the pair of the second short-width direction adhesive members 47B. In other words, the first short-width direction adhesive member 47A, the second short-width direction adhesive member 47B, and the third short-width direction adhesive member 47C are deviated from each other in the surface direction (the right and left direction) of the reflection-type polarizing plate 43, and consequently, all the adhesive layers 44 are deviated from each other in the surface direction of the reflection-type polarizing plate 43.

The first short-width direction adhesive member 47A, the second short-width direction adhesive member 47B, and the third short-width direction adhesive member 47C in the left side (the left side in FIG. 6) of the reflection-type polarizing plate 43 are arranged close to each other, forming a left short-width direction adhesive member group 47L. And also, the first short-width direction adhesive member 47A, the second short-width direction adhesive member 47B, and the third short-width direction adhesive member 47C in the right side (the right side in FIG. 6) of the reflection-type polarizing plate 43 are arranged close to each other, forming a right short-width direction adhesive member group 47R. The left short-width direction adhesive member group 47L and the right short-width direction adhesive member group 47R are arranged in positions that divide the reflection-type polarizing plate 43 nearly equally into three in the longitudinal direction. The spaces between the short-width direction adhesive members 47 constituting each of the short-width direction adhesive member groups 47L and 47R are nearly the same.

The first short-width direction adhesive member 47A, the second short-width direction adhesive member 47B, and the third short-width direction adhesive member 47C in the upper, middle, and lower stages respectively are arranged so as to form a straight line in the vertical direction. In other words, the first short-width direction adhesive member 47A, the second short-width direction adhesive member 47B, and the third short-width direction adhesive member 47C in the upper, middle, and lower stages respectively are in positions nearly the same in the width direction of the reflection-type polarizing plate 43. The length of all the short-width direction adhesive members 47 are approximately the same and shorter than the space between the upper and the lower longitudinal adhesive member groups 46U and 46S. In addition, both ends in the length direction of all the short-width direction adhesive members 47 are separated from the upper and lower edges of the reflection-type polarizing plate 43 and the upper and the lower longitudinal adhesive member groups 46U and 46S. The short-width direction adhesive members 47 are arranged in line-symmetric positions across a center line in the longitudinal direction (the right and left direction) of the reflection-type polarizing plate 43.

The center part in the longitudinal direction of the upper and lower longitudinal adhesive member groups 46U and 46S and the right and left short-width direction adhesive member groups 47L and 47R form a frame shape having four slits. Specifically, the slits are the separated parts between both ends in the longitudinal direction of the right and left short-width direction adhesive member groups 47L and 47R in the middle stage and the upper and lower longitudinal adhesive member groups 46U and 46S.

The reflection-type polarizing plate 43 are divided generally in nine divisions by the right and left short-width direction adhesive member groups 47L and 47R and the upper and lower longitudinal adhesive member groups 46U and 46S. Each division of the reflection-type polarizing plate 43 has a laterally long rectangular shape. The central division in the reflection-type polarizing plate 43 (referred to as a central division 43C) has a frame shape having four slits in its four corners and is surrounded and constrained by the central parts in the longitudinal direction of the upper and lower longitudinal adhesive member groups 46U and 46S and the right and left short-width direction adhesive member groups 47L and 47R in the middle stage.

In divisions positioned in four corners of the reflection-type polarizing plate 43 (referred to as corner divisions 43A), the upper corner divisions 43A are constrained on their lower sides by the upper longitudinal adhesive member group 46U, while being constrained on one of the left and right sides by the right and left short-width direction adhesive member groups 47L and 47R in the upper stage. The lower corner divisions 43A are constrained on their upper sides by the lower longitudinal adhesive member group 46S, while being constrained on one of the left and right sides by the right and left short-width direction adhesive member groups 47L and 47R in the lower stage. Each corner division 43A is held between the liquid crystal panel 11 and the diffuser plate 41 on one of the right and left side, that is opposite to the side constrained by the right and left short-width direction adhesive member groups 47R and 47L. In short, the corner division 43A is constrained on its three sides excepting the upper or the lower side.

The divisions positioned in right and left from the central division 43C in the reflection-type polarizing plate 43 (referred to as side edge divisions 43S) are constrained on the upper and lower sides by the upper and lower longitudinal adhesive member groups 46U and 46S, while being constrained on one of the right and left sides by the right and left short-width direction adhesive member groups 47R and 47L in the middle stage. Each side edge division 43S is held between the liquid crystal panel 11 and the diffuser plate 41 on one of the right and left side, that is opposite to the side constrained by the right and left short-width direction adhesive member groups 47R and 47L.

Additionally, the divisions positioned in the upper and lower sides of the central division 43C in the reflection-type polarizing plate 43 (referred to as upper and lower edge divisions 43U) are constrained on one of the upper and lower sides by the upper and lower longitudinal adhesive member groups 46U and 46S, while being constrained on one of the right and left sides by the right and left short-width direction adhesive member groups 47L and 47R in the upper and lower stages. In addition, each of the upper and lower edge divisions 43U is not constrained on the upper side or the lower side that is opposite to the side constrained by the upper and lower longitudinal adhesive member groups 46U and 46S.

According to the present embodiment constituted as mentioned above, the following effects can be expected.

In the present embodiment, the reflection-type polarizing plate 43 and the diffuser plate 41 are adhered by the adhesive layer 44 attached partially within an area provided so as to oppose to the display area of the liquid crystal panel 11. This divides the reflection-type polarizing plate 43 into nine partially constrained divisions 43C, 43A, 43S, and 43U, and in thermal expansion, deflection occurs in each of these divisions 43C, 43A, 43S, and 43U. The deflection amount in each division 43C, 43A, 43S, and 43U is smaller as compared with the conventional case where the entire reflection-type polarizing plate is deflected, and wrinkles are therefore hardly formed in the reflection-type polarizing plate 43 comparing to the conventional arts. Even when the reflection-type polarizing plate 43 is deflected, the deflection amount is small, and wrinkles remain in positions separated from the liquid crystal panel 11. Wrinkles therefore become inconspicuous, and deterioration of display quality can be prevented. When the refractive index of the adhesive layer 44 is greater than that of the reflection-type polarizing plate 43, and even when the light emitted from the diffuser plate 41 is totally reflected when falling from the adhesive layer 44 onto the reflection-type polarizing plate 43, the luminance can be prevented from lowering since the adhesive layer 44 is only partially attached.

The optical sheet laminate 40 has the longitudinal adhesive member 46 constituted by attaching the adhesive layer 44 in a thin and long streak shape extending in the longitudinal direction of the reflection-type polarizing plate 43 and the short-width direction adhesive member 47 constituted by attaching the adhesive layer 44 in a thin and long streak shape extending in the short-width direction of the reflection-type polarizing plate 43. This causes wrinkles to form along the longitudinal adhesive member 46 and the short-width direction adhesive member 47, and such wrinkles are inconspicuous as compared to irregular wrinkles. Therefore, deterioration of display quality can be prevented.

In addition, a plurality of the longitudinal adhesive members 46 are provided and arranged in line-symmetric positions across a center line in the short-width direction of the reflection-type polarizing plate 43. A plurality of the short-width direction adhesive members 47 are provided and arranged in line-symmetric positions across a center line in the longitudinal direction of the reflection-type polarizing plate 43. With such a configuration, even wrinkles, which are inconspicuous as compared to irregular wrinkles, may be easily formed in the reflection-type polarizing plate 43, and thereby preventing deterioration of display quality.

In addition, the upper and lower longitudinal adhesive member groups 46U and 46S and the right and left short-width direction adhesive member groups 47L and 47R in the adhesive layers 44 form a frame shape having four slits. Here, with the longitudinal adhesive member and the short-width direction adhesive member forming a closed frame shape, and when the thermal expansion of the reflection-type polarizing plate is larger than that of the diffuser plate, the part surrounded tightly by the longitudinal adhesive members and the short-width direction adhesive members on its entire circumference is constrained on its all four sides and cannot expand in the surface direction. This deflects the entire optical sheet. However, with the four slits, the slit parts (the part not constrained) can expand in the surface direction. This can reduce the deflection amount of the reflection-type polarizing plate as far as the slit parts, thereby making the wrinkles inconspicuous.

Additionally, the multiple adhesive layers 44 (the first adhesive layer 44A, the second adhesive layer 44B, and the third adhesive layer 44C) in the reflection-type polarizing plate 43 are deviated from each other in the surface direction of the reflection-type polarizing plate 43. Here, when the multiple adhesive layers are arranged in positions coincided with each other in the surface direction of the reflection-type polarizing plate, the adhesive layers are superimposed across the thickness direction of the optical sheet laminate and hardly transmit light. However, the multiple adhesive layers 44 (the first adhesive layer 44A, the second adhesive layer 44B, and the third adhesive layer 44C) are deviated from each other in the surface direction of the reflection-type polarizing plate 43 so as to easily transmit light, and thereby lowering the level of luminance reduction.

According to the present embodiment as mentioned above, the reflection-type polarizing plate 43 and the diffuser plate 41 are adhered by the adhesive layer 44 attached partially within an area provided so as to oppose to the display area of the liquid crystal panel 11, such that the reflection-type polarizing plate 43 is partially constrained, thereby reducing the deflection amount as compared to the case where the entire reflection-type polarizing plate is deflected. Wrinkles therefore become inconspicuous, and deterioration of display quality can be prevented. When the refractive index of the adhesive layer 44 is greater than that of the reflection-type polarizing plate 43, and even when the light emitted from the diffuser plate 41 is totally reflected when falling from the adhesive layer 44 onto the reflection-type polarizing plate 43, the luminance can be prevented from lowering since the adhesive layer 44 is only partially attached.

### Other Embodiments

The present invention is not limited to the embodiment described in the above with reference to the accompanying figures, and, for example, the following can also be included in the technical scope of the present invention.

(1) In the above embodiment, the longitudinal adhesive member 46 and the short-width direction adhesive member 47 extend continuously in the longitudinal and the short-width directions respectively, however, they are not necessarily extend continuously. For example, a plurality of dots of these adhesive members may be aligned intermittently in the longitudinal and the short-width directions of the reflection-type polarizing plate.

(2) In the above embodiment, four slits are provided in the four corners of a frame shape formed by the upper and lower longitudinal adhesive member groups 46U and 46S and the right and left short-width direction adhesive member groups 47L and 47R, however, the present invention is not limited to the above, and at least a slit may be provided. Additionally, slits may be provided in, for example, the middle parts in the four sides forming a frame shape. In short, the important thing is that the longitudinal adhesive member and the short-width direction adhesive member form an unclosed frame shape.

(3) In the above embodiment, the optical sheet is the reflection-type polarizing plate 43, however, the present invention is not limited to the above, and the optical sheet may be, for example, a lens sheet and the like having a light focusing effect toward the front side.

(4) In the above embodiment, the reflection-type polarizing plate 43 is adhered to the diffuser sheet 42, that is arranged right behind, by the adhesive layer 44, and the diffuser sheet 42 is adhered to the other diffuser sheet 42 by the adhesive layer 44, and then this diffuser sheet 42 is adhered to the diffuser plate 41 by the adhesive layer 44. This consequently adheres the reflection-type polarizing plate 43 to the diffuser plate 41. However, the present invention is not limited to the above, and, for example, the diffuser sheet provided between the reflection-type polarizing plate and the diffuser plate may be smaller than the reflection-type polarizing plate, such that the reflection-type polarizing plate and the diffuser plate are directly adhered each other.

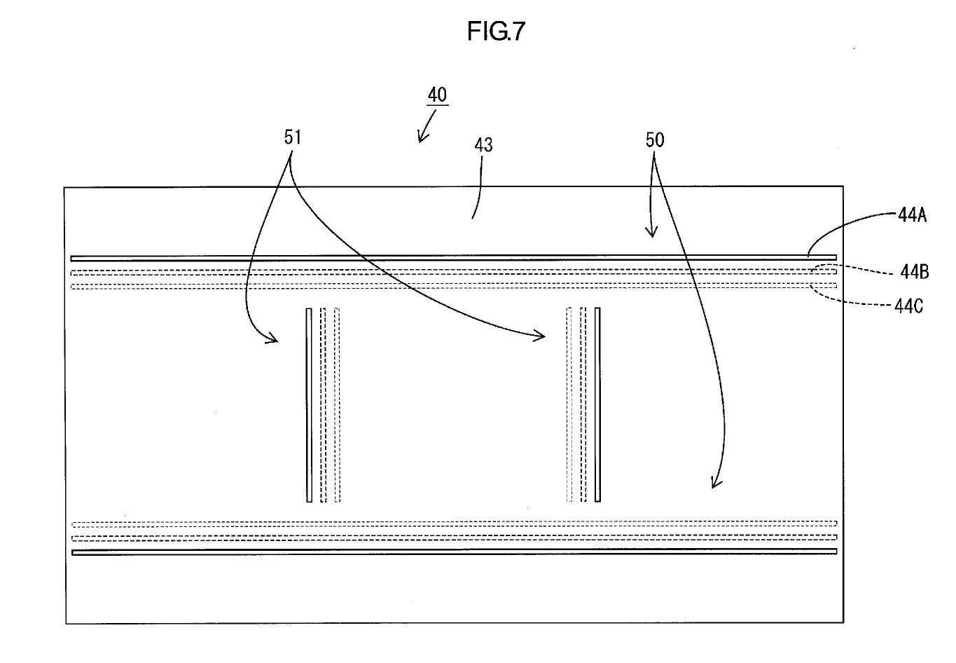

(5) In the above embodiment, the optical sheet laminate 40 has the longitudinal adhesive member groups 46U and 46S constituted by vertically arranging the adhesive layer 44 and the short-width direction adhesive member groups 47L and 47R arranged in the upper, middle, and lower stages, however, the present invention is not limited to the above. The adhesive layer in the optical sheet laminate may be attached in any forms. For example, the optical sheet laminate may have a longitudinal adhesive member extending in the longitudinal direction at the center position in the short-width direction of the reflection-type polarizing plate and a short-width direction adhesive member extending in the short-width direction at the center position in the longitudinal direction of the reflection-type polarizing plate. As shown in FIG. 7, the optical sheet laminate may have, for example, longitudinal adhesive member groups 50 arranged upper and lower sides and a pair of short-width direction adhesive member groups 51 arranged between the longitudinal adhesive member groups 50.

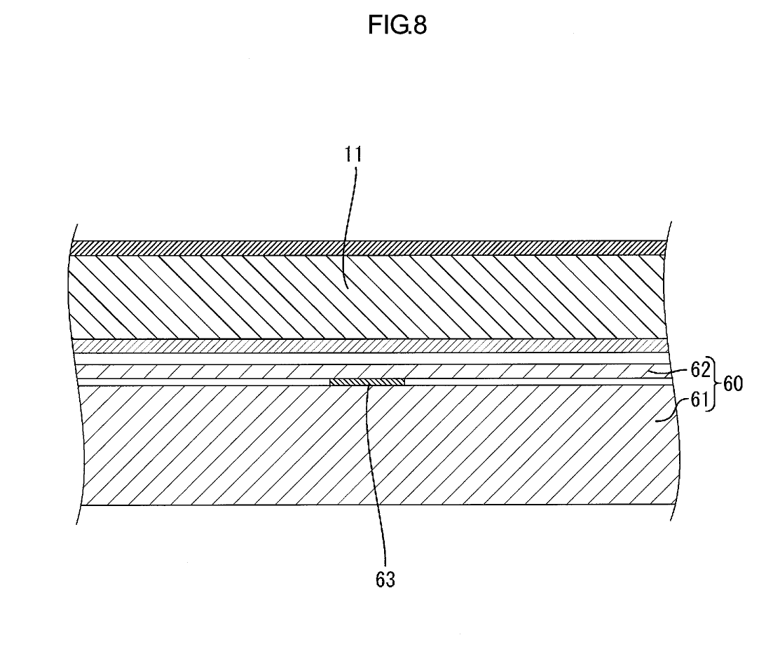

(6) In the above embodiment, the optical sheet laminate 40 is constituted by sequentially laminating two diffuser sheets 42 and the reflection-type polarizing plate 43 in the front side of the diffuser plate 41, however, the present invention is not limited to this. As shown in FIG. 8, for example, an optical sheet laminate 60 may be constituted by laminating only a reflection-type polarizing plate 62 to a diffuser plate 61. In such a case, the reflection-type polarizing plate 62 may be directly adhered to the diffuser plate 61 by an adhesive layer 63.

1. An optical sheet laminate arranged between a light source and a display panel for displaying images using light emitted from the light source, the optical sheet laminate comprising:
a diffuser plate configured to diffuse light emitted from the light source; and
an optical sheet through which light from the diffuser plate passes, the optical sheet being bonded to the diffuser plate with an adhesive applied to a part of an area thereof opposite a display area of the display panel.

2. The optical sheet laminate according to claim 1, wherein the adhesive is in a linear shape.

3. The optical sheet laminate according to claim 1, wherein the adhesive is in a linear shape with a substantially constant width.

4. The optical sheet laminate according to claim 1, wherein:
the optical sheet is in a rectangular shape; and
the adhesive layer is in a linear shape extending along a side edge of the optical sheet.

5. The optical sheet laminate according to claim 4, further comprising a plurality of long adhesive portions including adhesives in liner shapes extending along a long-side edge of the optical sheet, the long adhesive portions being line-symmetric to each other with respect to a line that connects midpoints of the short sides of the optical sheet.

6. The optical sheet laminate according to claim 4, further comprising a plurality of short adhesive portions including adhesives in linear shapes extending along a short-side edge of the optical sheet, the short adhesive portions being line-symmetric to each other with respect to a line that connects midpoints of the long sides of the optical sheet.

7. The optical sheet laminate according to claim 4, further comprising at least a pair of long adhesive portions and at least a pair of short adhesive portions forming a frame-like shape with at least one opening, wherein:
each of the long adhesive portions including an adhesive in a linear shape extends along a long-side edge of the optical sheet; and
each of the short adhesive portions including an adhesive in a linear shape extends along a short-side edge of the optical sheet.

8. The optical sheet laminate according to claim 1, further comprising at least one diffuser sheet arranged between the optical sheet and the diffuser plate and bonded to the optical sheet and the diffuser plate with adhesives applied between the optical sheet and the diffuser sheet, and between the diffuser sheet and the diffuser plate.

9. The optical sheet laminate according to claim 8, wherein the at least one diffuser sheet includes a plurality of diffuser sheets bonded together with the adhesives.

10. The optical sheet laminate according to claim 8, wherein the adhesives on different layers are arranged so as not to overlap each other in a plane corresponding to the surface of the optical sheet.

11. The optical sheet laminate according to claim 1, wherein the optical sheet is a reflection-type polarizing plate.

12. The optical sheet laminate according to claim 1, wherein the optical sheet is a lens sheet.

13. A backlight device comprising:
the optical sheet laminate according to claim 1; and
a light source configured to emit light to the optical sheet laminate.

14. A display device comprising: the backlight device according to claim 13; and
a display panel configured to provide display using light from the backlight device.

15. The display device according to claim 14, wherein the display panel is a liquid crystal panel using liquid crystals.

16. A television receiver comprising the display device according to claim 14.
